(19) United States
(12) Patent Application Publication
(10) Pub. No.: US 2015/0160401 A1
(43) Pub. Date: Jun. 11, 2015

(54) BACKLIGHT AND LIQUID-CRYSTAL DISPLAY APPARATUS USING THE SAME

(71) Applicant: Japan Display Inc., Minato-ku (JP)

(72) Inventors: Yuki NAMEKATA, Minato-ku (JP); Junya YAMAMOTO, Minato-ku (JP)

(73) Assignee: Japan Display Inc., Minato-ku (JP)

(21) Appl. No.: 14/521,968

(22) Filed: Oct. 23, 2014

(30) Foreign Application Priority Data
Dec. 6, 2013 (JP) 2013-253273

(51) Int. Cl. F21V 8/00; G02F 1/1335

(52) U.S. Cl. CPC G02B 6/0053; G02F 1/1336; G02B 6/0088

(57) ABSTRACT

A backlight includes: a light guide plate on which blue light from the blue LED falls; a quantum dot enhancement film laminated on the light guide plate and configured to convert blue light passing therethrough into light having peak characteristic for green and red; a frame configured to house the light guide plate and the quantum dot enhancement film, and an inner peripheral surface of the frame has a reflectivity not higher than 50% with respect to the blue light from the blue LED.

### CROSS-REFERENCE TO RELATED APPLICATIONS

This application is based upon and claims the benefit of priority from the prior Japanese Patent Application No. 2013-253273, filed on Dec. 6, 2013; the entire contents of which are incorporated herein by reference.

### FIELD

The present invention relates to a backlight and a liquid-crystal display apparatus using the backlight.

### BACKGROUND

A liquid-crystal display apparatus of a mobile apparatus such as smart phones or tablet terminals is provided with a backlight having an edge-light type light guide plate for achieving a thin profile. The edge-light type backlight includes a light source such as a white LED on one side of the light guide plate and configured to effect a surface emission.

In recent years, a quantum dot enhancement film using quantum dots is commercialized. The quantum dot enhancement film employs a blue LED instead of a white LED of the related art, and is configured to emit white light by allowing blue light to pass through the quantum dot enhancement film. By using the quantum dot enhancement film, color reproducibility corresponding to an NTSC ratio of 100% is achieved.

The quantum dot enhancement film converts blue light into green light, converts blue light into red light, and emits blue light as-is. From the principle of the quantum dot enhancement film, since light which does not pass through the quantum dot enhancement film is emitted as blue light without change, there is a problem that blue light reflected from a frame goes out without passing through the quantum dot enhancement film at an end portion of the liquid-crystal display apparatus and hence colors around a liquid-crystal cell gleam out in blue.

In view of such a problem, it is an object of the invention to provide a backlight which does not cause the periphery of a liquid-crystal cell to gleam out in blue even though the backlight employs a blue LED and a quantum dot enhancement film, and a liquid-crystal display apparatus using the backlight.

### BRIEF DESCRIPTION OF THE DRAWINGS

FIG. 1 illustrates an exploded perspective view of a liquid-crystal display apparatus of a first embodiment;

FIG. 2 illustrates a plan view of the liquid-crystal display apparatus;

FIG. 3 illustrates a cross-sectional view taken along the line A-A in FIG. 2;

FIG. 4 is a cross-sectional view taken along the line B-B in FIG. 2;

FIG. 5 illustrates a vertical cross-sectional view, partly in an enlarged scale, of the liquid-crystal display apparatus;

FIG. 6 illustrates a vertical cross-sectional view, partly in an enlarged scale, of the liquid-crystal display apparatus of a second embodiment;

FIG. 7 illustrates a vertical cross-sectional view, partly in an enlarged scale, of a third embodiment;

FIG. 8 illustrates a vertical cross-sectional view, partly in an enlarged scale, of a fourth embodiment; and

FIG. 9 illustrates a vertical cross-sectional view, partly in an enlarged scale, of a fifth embodiment.

### DETAILED DESCRIPTION

A backlight of a liquid crystal display device according to an aspect of the present invention including: a blue LED; a light guide plate on which light from the blue LED falls; a quantum dot enhancement film laminated on the light guide plate and configured to convert light passing therethrough into light having peak characteristic for green and red; an optical film laminated on the quantum dot enhancement film; and a frame configured to house the light guide plate, the quantum dot enhancement film, and the optical film laminated on top of another, wherein an inner peripheral surface of the frame has a reflectivity not higher than 50% with respect to the light from the blue LED.

Furthermore, in the backlight according to an aspect of the present invention, the blue LED emits light having a peak wavelength in a range from 380 to 495 nm.

Furthermore, in the backlight according to an aspect of the present invention, the inner periphery of the frame has a spectral reflectivity not higher than 7% with respect to the wavelengths in a range from 380 to 495 nm.

Furthermore, in the backlight according to an aspect of the present invention, the color of the inner peripheral surface of the frame is at least black.

Furthermore, in the backlight according to an aspect of the present invention, black coating material is applied to the inner peripheral surface of the frame.

Furthermore, in the backlight according to an aspect of the present invention, the color of the frame is black.

Furthermore, in the backlight according to an aspect of the present invention, the frame is formed of two types of resin so that the color of the inner peripheral surface of the frame becomes black.

Furthermore, in the backlight according to an aspect of the present invention, the color of an upper portion of the inner peripheral surface of the frame is black.

Furthermore, in the backlight according to an aspect of the present invention, a light-shielding tape is adhered to the inner peripheral surface of the frame.

Furthermore, in the backlight according to an aspect of the present invention, the inner peripheral surface of the frame has a diffuse reflection characteristic.

Furthermore, in the backlight according to an aspect of the present invention, the backlight of the above described mode and a liquid-crystal cell are provided.

A liquid-crystal display apparatus 10 of embodiments of the invention will be described below with reference to the drawings.

Disclosure in the embodiment is examples only, and modifications which can be imagined easily by those skilled in the art without departing from the gist of the invention are included in the scope of the invention as a matter of course. In order to clarify the description, drawings may be schematically illustrated in terms of width, thickness, and shape differently from the reality. However, those illustrated in the drawings are not more than examples, and are not intended to limit the understanding of the invention.

In this specification and the drawings, the same components described in the drawings which have been described before are denoted by the same reference numerals and detailed description may be omitted as needed.

### First Embodiment

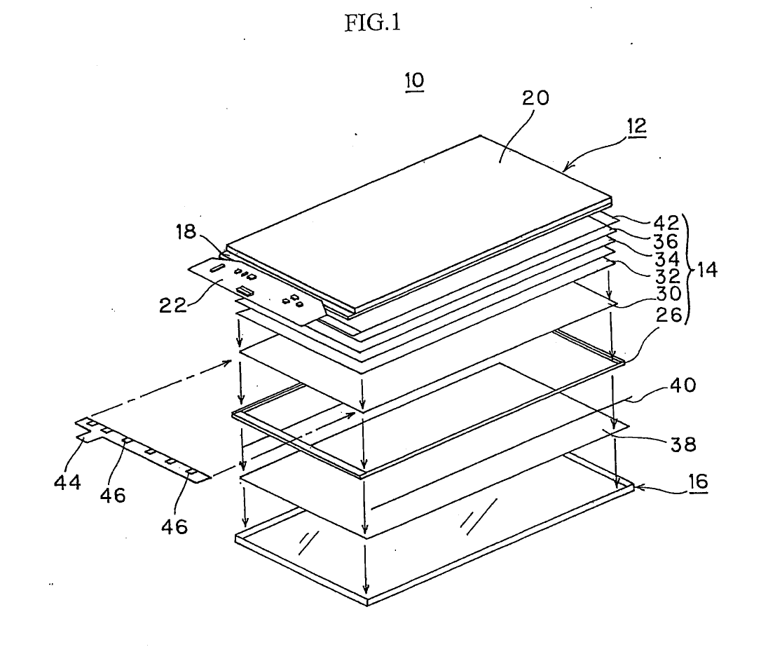

The liquid-crystal display apparatus 10 of a first embodiment will be described with reference to FIGS. 1 to 5.

### (1) Configuration of Liquid-Crystal Display Apparatus 10

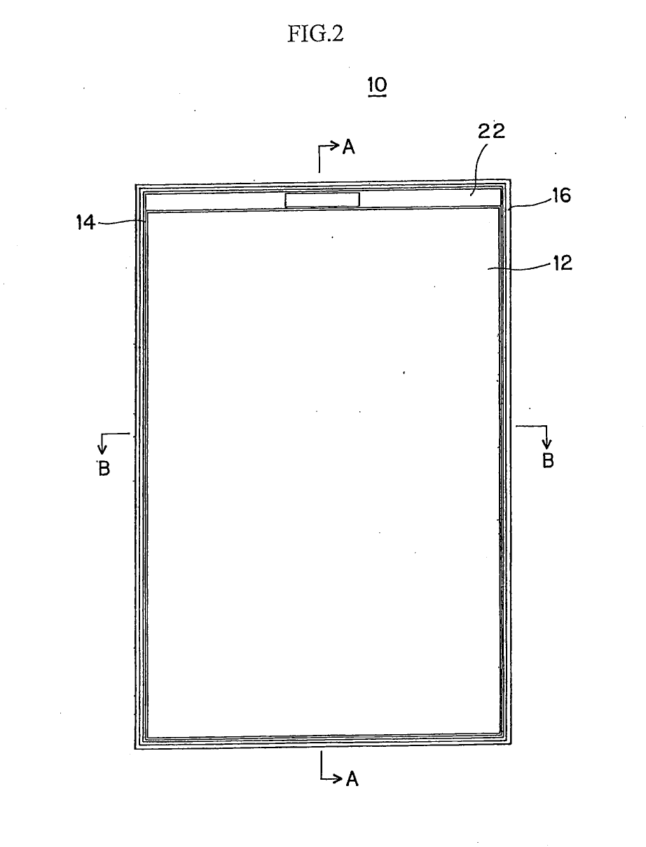

A configuration of the liquid-crystal display apparatus 10 will be described with reference to FIG. 1 and FIG. 2. FIG. 1 is an exploded perspective view of a liquid-crystal display apparatus 10, and FIG. 2 is a plan view.

The liquid-crystal display apparatus 10 includes a liquid-crystal cell 12, a backlight 14, and a metallic cover 16 configured to house the liquid-crystal cell 12 and the backlight 14.

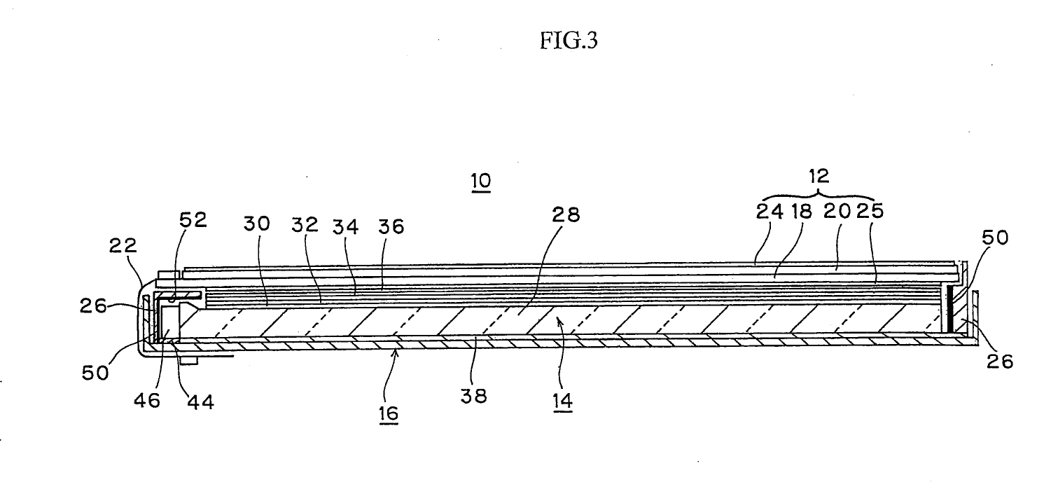

The liquid-crystal cell 12 includes an array substrate 18 having pixels formed in a matrix pattern and a counter substrate 20, and a liquid-crystal layer is interposed between the array substrate 18 and the counter substrate 20. The array substrate 18 is formed to be larger than the counter substrate 20, and includes a shelf portion and a flexible printed board 22 is mounted on the shelf portion. The flexible printed board 22 attached to the liquid-crystal cell 12 is arranged by being folded back to a back side of the cover 16 as illustrated in FIG. 3. Polarizing plates 24 and 25 are adhered to a front surface of the counter substrate 20 and a back surface of the array substrate, respectively.

### (2) Configuration of Backlight 14

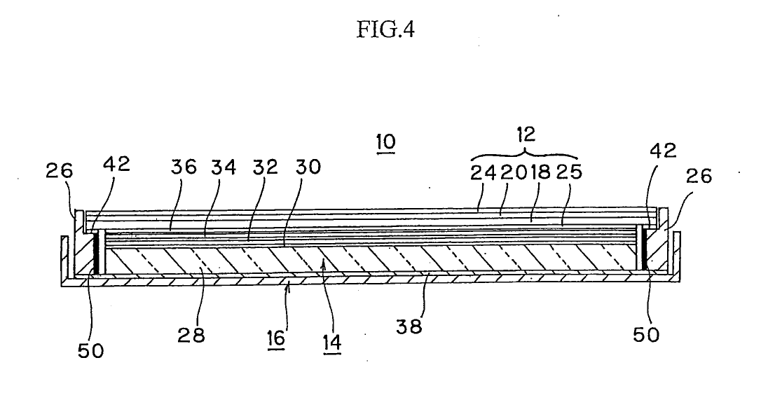

The backlight 14 will be described with reference to FIG. 3 to FIG. 4.

The backlight 14 includes a light guide plate 28, a quantum dot enhancement film 30, and optical films (a prism sheet 32, a prism sheet 34, and a dispersion sheet 36) stacked in this order and housed in the interior of a frame 26. A reflecting sheet 38 is disposed on a lower surface of the light guide plate 28.

The frame 26 is formed of a white synthetic resin, opened on an upper surface and a lower surface, and is provided with a shouldered portion 54 formed on an inner side of an upper end portion of the frame 26 so as to place the liquid-crystal cell 12 thereon. The lower surface of the frame 26 is adhered to a bottom surface of the cover 16 by using light-shielding double-sided tapes 40, and an edge portion of the back surface of the liquid-crystal cell 12 is fixed to the shouldered portion 54 located on the upper surface of the frame 26 by using a light-shielding double-sided tape 42.

A LED flexible substrate 44 is disposed on the side of a short side of the light guide plate 28 in the interior of the frame 26, and a plurality of blue LEDs 46 are arrayed on the LED flexible substrate 44 along the short side of the light guide plate 28 at predetermined intervals. The blue LEDs 46 emit blue light having a peak wavelength in a range from 380 to 495 nm toward a side surface of the light guide plate 28 as illustrated in FIG. 3. The blue light is incident from the side surface of the light guide plate 28 and propagates through the light guide plate 28.

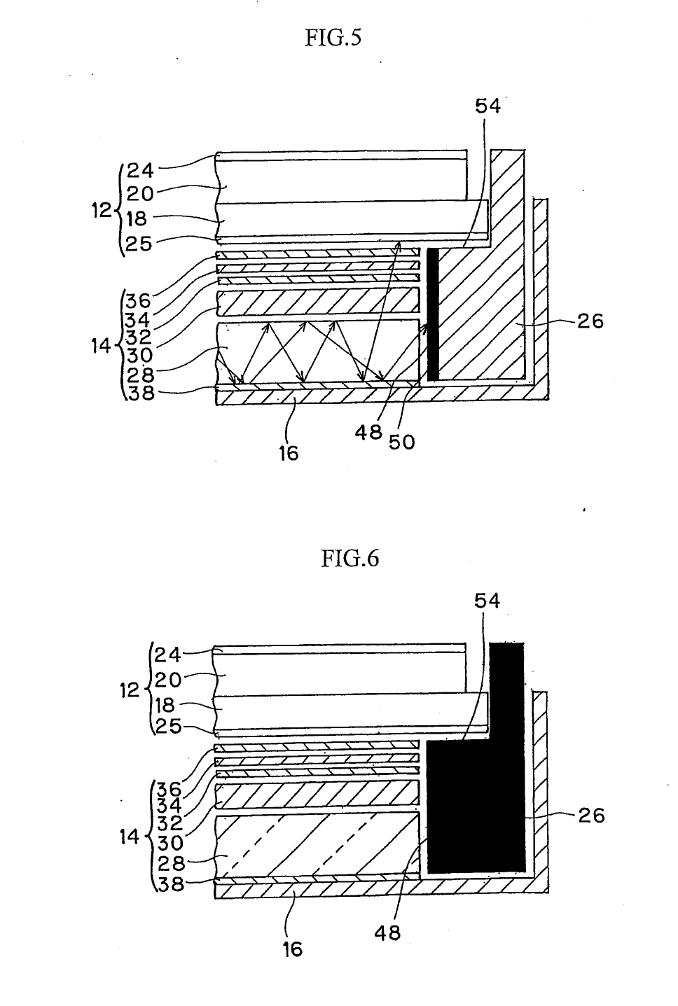

A quantum dot enhancement film (QDEF) 30 is a “QDEF (trademark)” formed of Sumitomo 3M Limited, for example, and has a structure including choroid-state quantum dots (QD; Quantum Dot) having diameters of 3 mm and 7 mm dispersed in a film and being sandwiched between protective films. As illustrated in FIG. 5, blue light from the blue LEDs 46 passes through the light guide plate 28 and gleams out in a sheet form, and the blue light is converted into green light by quantum dots having a diameter of 3 mm, is converted into red light by quantum dots having a diameter of 7 mm, and the blue light passes through the light guide plate 28 as-is. Consequently, a sheet-form light source having sharp peaks of red, green, and blue with respect to white LED having a broad wavelength characteristic of the related art is achieved, so that an image is provided with vivid hue.

A coating material having a reflectivity not higher than 50% with respect to the blue light from the blue LEDs 46, more preferably, a spectral reflectivity not higher than 7% with respect to the blue light having peak wavelengths in a range from 380 to 495 nm is applied to the inner peripheral surface of the synthetic resin made frame 26. Specifically, as illustrated in FIG. 5, the coating material 50 of a black color is applied to an inner peripheral surface 48 in which the light guide plate 28 in the frame 26, the quantum dot enhancement film 30, the prism sheets 32 and 34, and the dispersion sheet 36 are housed. The black coating material 50 is applied to the inner peripheral surface 48 of the frame 26 entirely on four sides as illustrated in FIG. 3 and FIG. 4. In particular, in the inner peripheral surface 48 side on which the blue LEDs 46 are arranged, the black coating material 50 is applied also to a ceiling surface 52 of the frame 26 located on upper surfaces of the blue LEDs 46.

### (3) Light Emitting State of Backlight 14

In the liquid-crystal display apparatus 10 of the first embodiment, if the plurality of blue LEDs 46 of the backlight 14 are caused to emit light, the blue light having a peak wavelength in a range from 380 to 495 nm is emitted from the blue LEDs 46 to the side surface of the light guide plate 28 as illustrated in FIG. 5. The blue light incoming into the light guide plate 28 is converted into green light by quantum dots having a diameter of 3 mm while being reflected by the reflecting sheet 38 and goes out in a sheet form onto the prism sheet 32, and the blue light is converted into red light by the quantum dots having a diameter of 7 mm and goes out in a sheet form onto the prism sheet 32. The blue light is emitted in a sheet form onto the prism sheet 32 as-is. In contrast, as illustrated in FIG. 5, the blue light having reached the peripheral portion of the light guide plate 28 on four sides is reflected by the inner peripheral surface of the frame 26 and reaches the peripheral portion of the liquid-crystal cell 12 as-is in the related art. However, in the first embodiment, since the black coating material 50 is applied to the inner peripheral surface of the frame 26, the blue light is not reflected and hence the four peripheral portions of the liquid-crystal cell 12 do not gleam out in blue.

### (4) Advantageous Effects

According to the first embodiment, since the blue light from the blue LEDs 46 is not reflected from the inner peripheral surface 48 of the frame 26, the peripheral portion of the liquid-crystal cell 12 does not gleam out in blue. Therefore, the invention may be applied to a module having a narrow frame without reducing the light-emitting area of the liquid-crystal cell 12.

### Second Embodiment

The liquid-crystal display apparatus 10 of a second embodiment will be described below with reference to FIG. 6.

In the first embodiment, the black coating material 50 is applied only to the inner peripheral surface 48 of the frame 26. However, in the second embodiment, the frame itself is formed of a black synthetic resin as illustrated in FIG. 6. Accordingly, reflection of the blue light from the blue LEDs 46 of the inner peripheral surface 48 of the frame 26 may be prevented.

### Third Embodiment

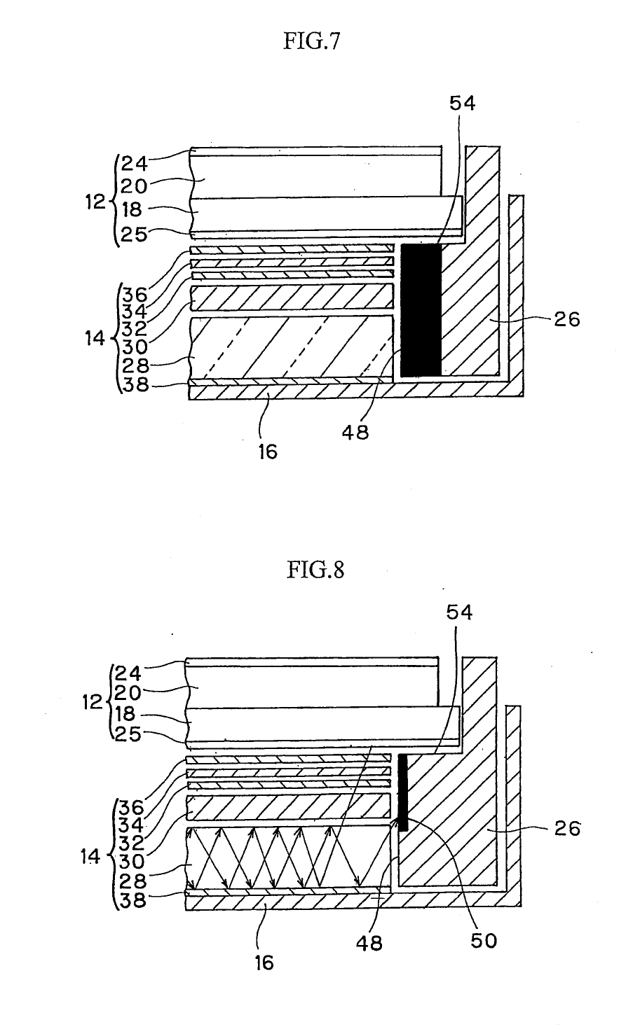

Subsequently, the liquid-crystal display apparatus 10 of a third embodiment will be described with reference to FIG. 7.

In the second embodiment, the frame 26 is formed entirely of the black synthetic resin. Instead, however, in the third embodiment, two-color molding in which only the inside of the frame 26 is formed of the black synthetic resin, and the outside is formed of a white synthetic resin.

Accordingly, with the configuration of the third embodiment as well, reflection of the blue light from the blue LEDs 46 from the inner peripheral surface 48 of the frame 26 may be prevented.

### Fourth Embodiment

Subsequently, the liquid-crystal display apparatus 10 of a fourth embodiment will be described with reference to FIG. 8.

The black coating material 50 is applied to the entire inner peripheral surface 48 of the frame 26 in the first embodiment. However, in the fourth embodiment, the black coating material 50 is applied only to the upper portion of the frame 26 which is expected to reflect the blue light as illustrated in FIG. 8. With the application of the coating material in this manner, the blue light from the blue LEDs 46 is prevented from being reflected and reaching the outer peripheral portion of the liquid-crystal cell 12.

### Fifth Embodiment

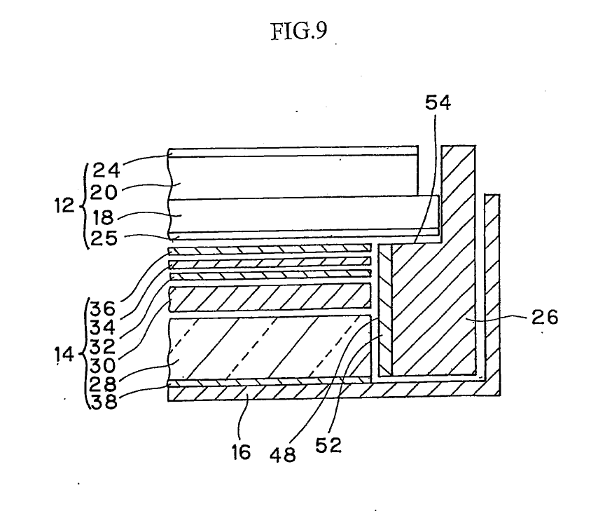

Subsequently, the liquid-crystal display apparatus 10 of a fifth embodiment will be described with reference to FIG. 9.

In the first embodiment, the black coating material 50 is applied to the inner peripheral surface 48 of the frame 26. Instead, however, in the fifth embodiment, a light-shielding tape 52 is adhered to a surface where the black coating material 50 is to be applied. With the configuration of the fifth embodiment as well, reflection of the blue light from the blue LEDs 46 may be prevented by the light-shielding tape 52.

### Modification

In the embodiments described above, the inner peripheral surface 48 of the frame 26 is formed to be black. However, the color is not limited to black, and may be other colors such as gray as long as the reflectivity with respect to the light from the blue LEDs 46 is not higher than 50% and, in particular, may be any color as long as the spectral reflectivity for the light from the blue LEDs 46 having a peak wavelength in a range from 380 to 495 nm is not higher than 7%.

In the embodiments described above, mirror reflection on the inner peripheral surface 48 of the frame 26 is prevented. In addition, a configuration in which the inner peripheral surface 48 is provided with depressions and projections to have a diffuse reflection characteristic and the blue light is prevented from reaching by the liquid-crystal cell 12 is also applicable.

According to the embodiments of the invention, all embodiments which may be implemented by those skilled in the art by modifying the design as needed are also included in the range of the present invention as long as the gist of the invention is included.

In the category of the thought of the invention, those skilled in the art may imagine various modifications or corrections, and examples of these modifications and corrections are considered to be included within the scope of the invention. For example, those added, deleted, or modified in design of the components by those skilled in the art, or those in which processes are added or deleted, or the conditions are changed with respect to the embodiments may be included within the range of the invention as long as the gist of the invention is included.

Those apparent from the description of the specification or imagined easily by those skilled in the art about other advantageous effects generated by the configuration described in the embodiment are considered by being generated by the invention as a matter of course.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A backlight to be mounted on a back side of a liquid-crystal cell, comprising:
a blue LED;
a light guide plate on which light from the blue LED falls;
a quantum dot enhancement film laminated on the light guide plate and configured to convert light passing therethrough into light having peak characteristic for green and red;
an optical film laminated on the quantum dot enhancement film; and
a frame configured to house the light guide plate, the quantum dot enhancement film, and the optical film laminated on top of another, wherein
an inner peripheral surface of the frame has a reflectivity not higher than 50% with respect to light from the blue LED.

2. The backlight according to claim 1, wherein a peak wavelength of light from the blue LED falls in a range from 380 to 495 nm.

3. The backlight according to claim 2, wherein the inner periphery of the frame has a spectral reflectivity not higher than 7% with respect to the wavelengths in a range from 380 to 495 nm.

4. The backlight according to claim 1, wherein the color of the inner peripheral surface of the frame is at least black.

5. The backlight according to claim 4, wherein a black coating material is applied to the inner peripheral surface of the frame.

6. The backlight according to claim 4, wherein the color of the frame is black.

7. The backlight according to claim 4, wherein the frame is formed of two types of resin and the color of the inner peripheral surface of the frame is black.

8. The backlight according to claim 1, wherein the color of an upper portion of the inner peripheral surface of the frame is at least black.

9. The backlight according to claim 1, wherein a light-shielding tape is adhered to the inner peripheral surface of the frame.

10. The backlight according to claim 1, wherein the inner peripheral surface of the frame has a diffuse reflection characteristic.

11. A liquid-crystal display apparatus comprising:
the backlight according to claim 1; and
a liquid-crystal cell.

12. A backlight of a liquid-crystal cell, comprising:
a light guide plate including a light emitting surface, a bottom surface opposed to the light emitting surface, a side surface intersected with the light emitting surface and the bottom surface;
a blue LED facing to the side surface for emitting a blue light to the light guide plate;
a quantum dot enhancement film laminated on the light emitting surface and configured to convert light passing therethrough into light having peak characteristic for green and red;
an optical film laminated on the quantum dot enhancement film; and
a frame configured to house the light guide plate, the quantum dot enhancement film, and the optical film laminated on top of another, wherein
a reflectivity of an inner peripheral surface of the frame is less than that of another part of the frame with respect to the blue light from the blue LED.

13. The backlight according to claim 12, wherein a peak wavelength of light from the blue LED in a range from 380 to 495 nm.

14. The backlight according to claim 12, wherein the inner periphery of the frame has a spectral reflectivity not higher than 7% with respect to the wavelengths in a range from 380 to 495 nm.

15. The backlight according to claim 12, wherein the color of the inner peripheral surface of the frame is at least black.

16. The backlight according to claim 15, wherein a black coating material is applied to the inner peripheral surface of the frame.

17. The backlight according to claim 15, wherein the frame is formed of two types of resin and the color of the inner peripheral surface of the frame is black.

18. The backlight according to claim 12, wherein the color of an upper portion of the inner peripheral surface of the frame is at least black.

19. The backlight according to claim 12, wherein a light-shielding tape is adhered to the inner peripheral surface of the frame.

20. The backlight according to claim 12, wherein the inner peripheral surface of the frame has a diffuse reflection characteristic.

21. A liquid-crystal display apparatus comprising:
the backlight according to claim 12; and
a liquid-crystal cell.
